(19) United States
(12) Patent Application Publication
(10) Pub. No.: US 2013/0129524 A1
(43) Pub. Date: May 23, 2013

(54) CENTRIFUGAL IMPELLER

(71) Applicant: Scott R. Sargent, Broomfield, CO (US)

(72) Inventors: Scott R. Sargent, Broomfield, CO (US); Sen Y. Meng, Reseda, CA (US)

(21) Appl. No.: 13/299,718

(22) Filed: Nov. 18, 2011

(51) Int. Cl. F01D 5/14; B23P 17/00

(52) U.S. Cl. 416/243; 29/888

(57) ABSTRACT

A centrifugal impeller includes a hub and a plurality of impeller blades extending from the hub. Each impeller blade extends over a chord length between a leading end and a trailing end, over a span from a root at the hub to a tip end and over a thickness between a convex side and a concave side. The blades collectively or individually have profiles that define a circumferential pitch (CP) with regard to a spacing distance between the leading ends of neighboring ones of the blades and blade angles at positions along the convex side of each blade between the leading end and the trailing end. The blades have a solidity value (S) defined as CD/CP that is less or equal to 1.0 and the blade angles (α) of each blade increase from the respective leading end to the corresponding trailing end.

### BACKGROUND

This disclosure relates to centrifugal pumps. Centrifugal pumps are known and used to move fluids, for example. A typical centrifugal pump includes rotating impeller blades that receive a fluid generally along the rotating axis and discharge the fluid radially outwards. There are efficiency losses as the impeller blades turn the flow of the fluid from axial to radial.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 schematically illustrates an example desalination system.

FIG. 2 illustrates an example turbopump machine.

FIG. 3 is an isolated perspective view of an example centrifugal impeller.

FIG. 4 an axial view of a two-dimensional projection of the centrifugal impeller of FIG. 3.

FIG. 5 is a graph of blade angle versus blade distance.

### DETAILED DESCRIPTION OF THE PREFERRED EMBODIMENT

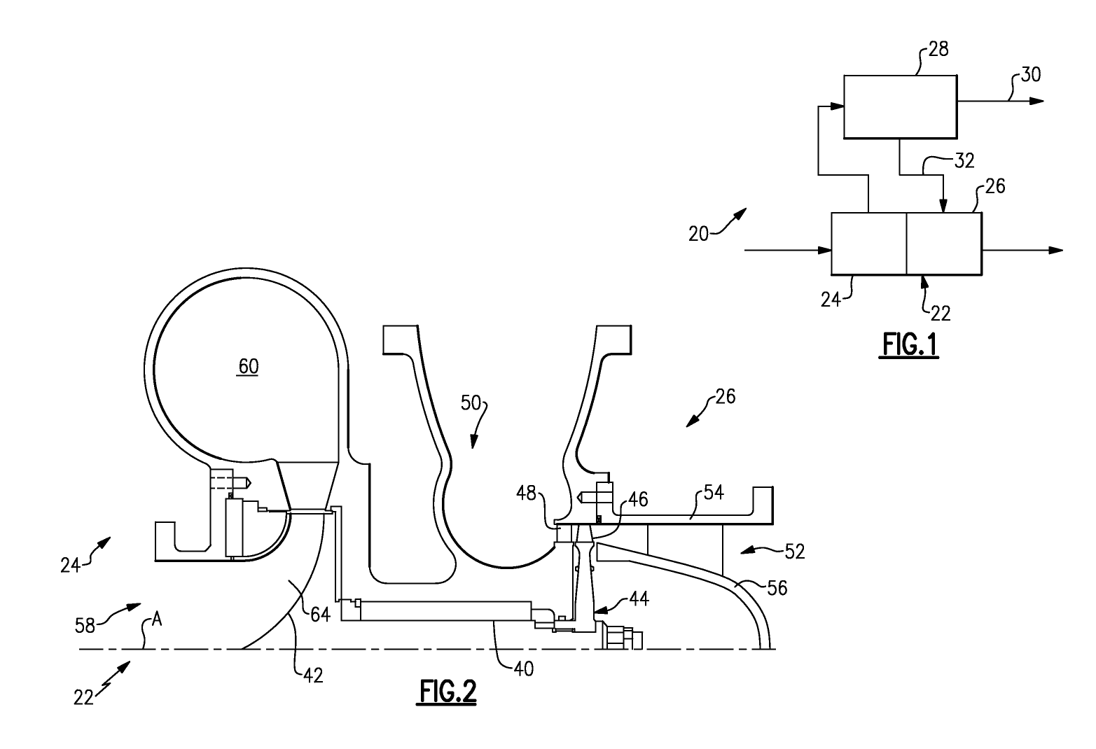

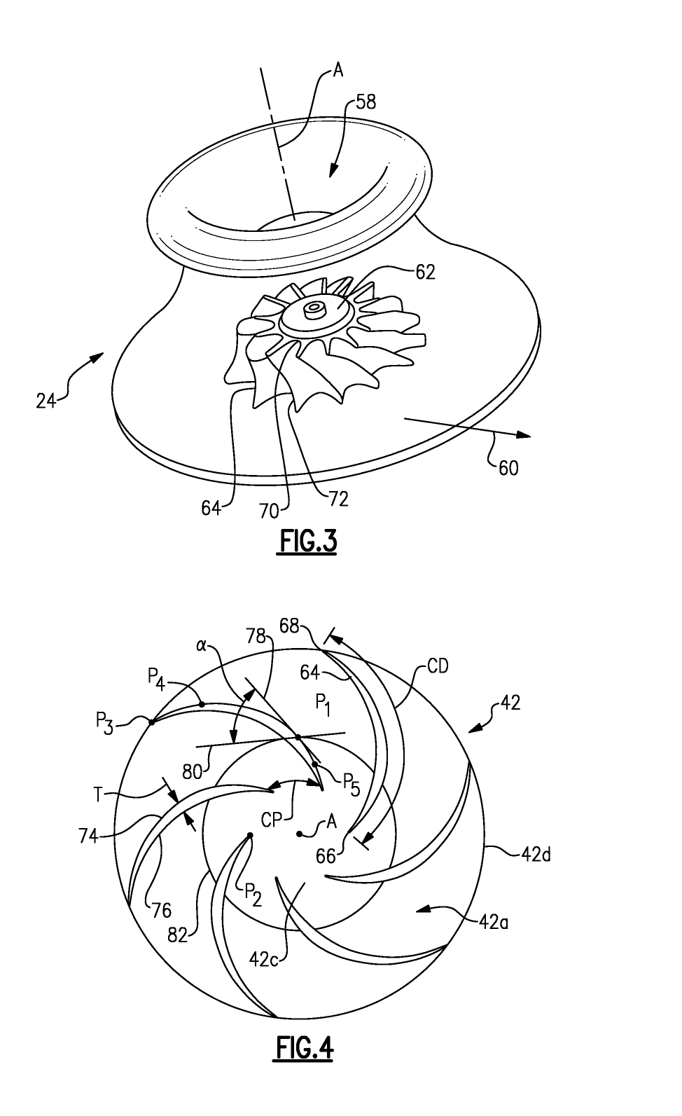

FIG. 1 schematically illustrates selected portions of an example desalination system 20, which provides an example operating environment for a turbopump machine 22 and centrifugal impeller 42 (FIG. 2) that will be described in more detail below. It is to be understood that the desalination system 20 is only an exemplary end use environment and that other systems, such as but not limited to aircraft or aerospace systems and turbine engines, will also benefit from the disclosed turbopump machine 22 or centrifugal impeller 42.

In the illustrated example, the turbopump machine 22 includes a pump section 24 and a turbine section 26. The turbopump machine 22 is fluidly connected with a reverse osmosis device 28 of known construction, for the desalination of water.

In the illustrated example, feed water is received into the pump section 24, which pressurizes the feed water and moves the feed water to the reverse osmosis device 28. As an example, the reverse osmosis device 28 includes one or more membranes to separate the feed water into a low-salinity stream 30 and a saline stream 32. The saline stream 32 is fed into the turbine section 26 of the turbopump machine 22, for energy recovery.

FIG. 2 illustrates a portion of an example of the turbopump machine 22. The pump section 24 and the turbine section 26 are coupled with a rotatable shaft 40 for rotation about axis A. The pump section 24 includes a centrifugal impeller 42 that is coupled to rotate with the rotatable shaft 40.

The turbine section 26 is coupled to drive the rotatable shaft 40, and thus the centrifugal impeller 42 of the pump section 24. The turbine section 26 includes an axial rotor 44 (e.g., turbine) having a plurality of blades 46 (one shown). In this example, the turbine section 26 also includes a plurality of fixed stator vanes 48 located upstream from the axial rotor 44. The turbine section 26 may have one or more stages of blades 46, vanes 48 or both.

The turbine section 26 includes an inlet 50 upstream from the blades 46 and an outlet 52 downstream from the blades 46. In the example shown, the outlet 52 is an annular outlet that extends between an outer wall 54 and an inner wall 56.

The pump section 24 includes an inlet 58 upstream from the centrifugal impeller 42 and an outlet 60 downstream from the centrifugal impeller 42.

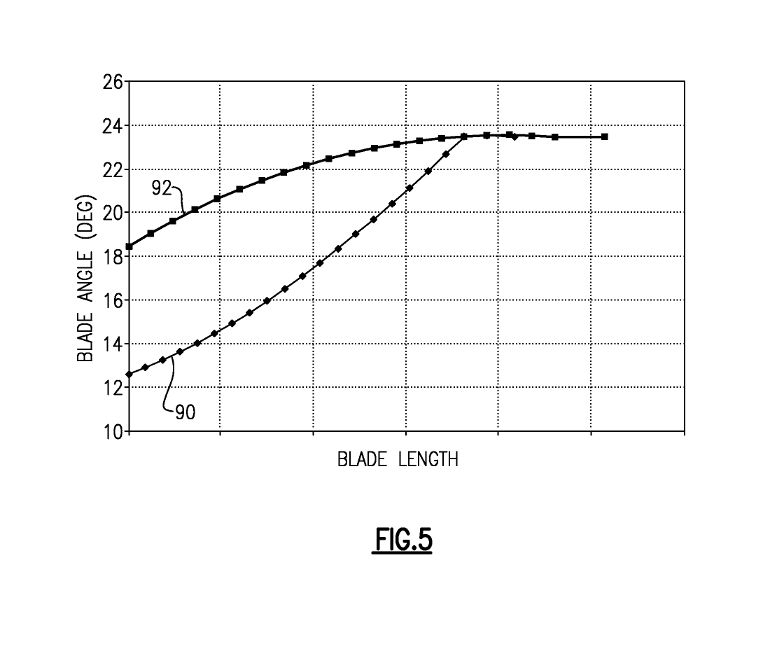

FIG. 3 shows an isolated view of a portion of the pump section 24 and FIG. 4 shows an axial view of a two-dimensional projection of the centrifugal impeller 42. The centrifugal impeller 42 includes a hub 62 having a plurality of impeller blades 64 that extend there from. Respective passages 42a extend between neighboring ones of the impeller blades 64. The fluid enters each passage 42a through a respective passage inlet 42c and is discharged through a respective passage outlet 42d.

Each impeller blade 64 extends over a chord length (CD) between a leading end 66 and a trailing end 68, over a span from a root 70 at the hub to a tip end 72 (FIG. 2) and over a thickness (T) between a convex side 74 and a concave side 76.

The impeller blades 64 collectively or individually have profiles that define a circumferential pitch (CP) with regard to a spacing distance between the leading ends 66 of neighboring ones of the blades 64. For example, the non-dimensional circumferential pitch (CP) is equal to 2π divided by the number of blades 64.

The impeller blades 64 also collectively or individually have profiles that define blade angles (α) at positions P₁-P₅ along the convex side 74 of each blade 64 between the leading end 66 and the trailing end 68. In the illustrated example, position P₁ is located at an intermediate radial distance between the leading end 66 and the trailing end 68, position P₂ is located at the leading end 66, position P₃ is located at the trailing end 68, position P₄ is located at an intermediate radial distance between the leading end 66 and the trailing end 68 which is closer to the trailing end 68 than P₁, and position P₅ is located at an intermediate radial distance between the leading end 66 and the trailing end 68 which is closer to the leading end 66 than P₁. It is to be understood, however, that the positions can be located at the leading end 66, the trailing end 68 or in between, and may be at the hub 62, tip end 72 or in between.

Each blade angle (α) is the angle between a first line 78 and a second line 80. The first line 78 is tangent to the convex side 74 of the respective blade 64 at the given position. The second line 80 is tangent to a mean radius line 82 between an inner radius at the leading ends 66 and an outer radius at the trailing ends 68 at a point of intersection between the convex side 74 of the respective blade 64 and the second line 80. In the example shown, the point of intersection is also the position P₁. In one example, the blade angles (α) at all positions are 12°-24°. Alternatively, the blade angles (α) can be converted to a different reference system that is based on other reference lines or points of reference.

In a further example, the blade angle (α) of each blade 64 at the hub 62 is greater than the blade angle (α) of each blade 64 at the tip end 72 at an intermediate radial distance from the axis A between the leading ends 66 and the tailing ends 68, such as at a radial distance corresponding to position P₅.

In a further embodiment, the blade angle (α) of each blade 64 at the hub 62 is greater than the blade angle (α) of each blade 64 at the tip end 72 at each of a plurality of radial distances from the axis A between the leading ends and the tailing ends, such as at radial distances corresponding to positions P₁ and P₅.

In a further example, the blade angle (α) of each blade 64 at the hub 62 is equal to the blade angle (α) of each blade 64 at the tip end 72.

The profile of the impeller blades 64 with regard to the chord length (CD) and the circumferential pitch (CP) define a solidity value (S) of CD/CP. In the illustrated example, the solidity value (S) is less than or equal to 1.0. Further, the profile of the impeller blades 64 with regard to the blade angles (α) of each blade 64 increase from the respective leading end 66 to the corresponding trailing end 68. In a further example, the profile with regard to solidity (S) and blade angle (α) can be represented by a ratio of blade angle(s) to solidity (blade angle divided by solidity) and is 12-24 at all positions on the blades 64.

FIG. 5 shows a graph of impeller blade angle versus blade length from the leading end 66. Plot line 90 represents blade angles versus blade length for angles at the tip end 72 and plot line 92 represents blade angles versus blade length for angles at the hub 62. As shown, the blade angles at the tip end 72 and at the hub 62 increase from the leading end 66 until the angles are equal at the trailing end 68 (as represented by the intersection and coextension of the plot lines 90 and 92 near the right side of the graph).

The passage inlets 42c, passage outlets 42d and the profiles of the impeller blades 64 with regard to the solidity value (S) and increasing blade angles (α) control flow velocity of fluid through the centrifugal impeller 42. For example, the profiles with regard to the solidity value (S) and increasing blade angles (α) provide a synergistic effect such that under steady state operation of the centrifugal impeller 42 there is a ratio (R) of an outlet meridonal flow velocity to an inlet meridonal flow velocity (outlet meridonal flow velocity divided by inlet meridonal flow velocity) that is 0.8-1.2. Thus, there is a limited change in meridonal flow velocity between the inlet 42c and outlet 42d as the impeller blades 64 turn the fluid from axial flow to radial flow. Physically, the limited change in meridonal flow velocity limits loading on the impeller blades 64 and thus extends impeller lifetime and reduces diffusion and efficiency losses. The centrifugal impeller 42 therefore enhances pumping efficiency and lowers operational cost. A maximum or further efficiency increase is obtained when the ratio (R) is approximately 1.0.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An centrifugal impeller comprising:
a hub; and
a plurality of impeller blades extending from the hub, each impeller blade extending over a chord length (CD) between a leading end and a trailing end, over a span from a root at the hub to a tip end and over a thickness between a convex side and a concave side, the plurality of impeller blades collectively or individually having profiles defining:
a circumferential pitch (CP) with regard to a spacing distance between the leading ends of neighboring ones of the blades, and
blade angles (α) at positions along the convex side of each blade between the leading end and the trailing end,
wherein the plurality of impeller blades have a solidity value (S) defined as CD/CP that is less than or equal to 1.0 and the blade angles (α) of each blade increase from the respective leading end to the corresponding trailing end.

2. The impeller as recited in claim 1, including respective passages between neighboring ones of the blades, each passage extending between an inlet and an outlet such that the profiles are operable to define a ratio (R) of an outlet meridonal flow velocity to an inlet meridonal flow velocity (outlet meridonal flow velocity divided by inlet meridonal flow velocity) that is 0.8-1.2.

3. The impeller as recited in claim 2, wherein the ratio (R) is approximately 1.0.

4. The impeller as recited in claim 1, wherein, for any one of the positions along the convex side each blade, the blade angle (α) is between a first line that is tangent to the convex side of the respective blade at the position and a second line that is tangent to a mean radius line between an inner radius of the leading ends and an outer radius of the trailing ends at a point of intersection between the convex side of the respective blade and the second line.

5. The impeller as recited in claim 4, wherein the blade angles (α) are 12°-24°.

6. The impeller as recited in claim 4, wherein the plurality of impeller blades are rotatable with regard to a central axis, and the blade angle (α) of each blade at the hub is greater than the blade angle (α) of each blade at the tip end at an intermediate radial distance from the axis between the leading ends and the tailing ends.

7. The impeller as recited in claim 4, wherein the plurality of impeller blades are rotatable with regard to a central axis, and the blade angle (α) of each blade at the hub is greater than the blade angle (α) of each blade at the tip end at each of a plurality of radial distances from the axis between the leading ends and the tailing ends.

8. The impeller as recited in claim 4, wherein at the trailing end of each blade, the blade angle (α) of each blade at the hub is equal to the blade angle (α) of each blade at the tip end.

9. The impeller as recited in claim 4, wherein the plurality of impeller blades are rotatable with regard to a central axis, and the blade angle (α) of each blade at the hub is greater than the blade angle (α) of each blade at the tip end at each of a plurality of radial distances from the axis between the leading ends and the tailing ends, and at the trailing end of each blade, the blade angle (α) at the hub is equal to the blade angle (α) at the tip end, and wherein the blade angles (α) at the plurality of radial distances and the blade angles (α) at the trailing end of each blade at the hub and at the tip end are 12°-24°.

10. The impeller as recited in claim 4, wherein over the chord length a ratio of blade angle (α) to solidity (blade angle divided by solidity) is 12-24.

11. A turbopump machine comprising:
a rotatable shaft;
a pump coupled to rotate with the rotatable shaft, the pump including a centrifugal impeller comprising a hub and a plurality of impeller blades extending from the hub, each impeller blade extending over a chord length (CD) between a leading end and a trailing end, over a span from a root at the hub to a tip end and over a thickness between a convex side and a concave side, the plurality of impeller blades collectively or individually having profiles defining:
a circumferential pitch (CP) with regard to a spacing distance between the leading ends of neighboring ones of the blades, and
blade angles (α) at positions along the convex side of each blade between the leading end and the trailing end,
wherein the plurality of impeller blades have a solidity value (S) defined as CD/CP that is less than or equal to 1.0 and the blade angles (α) of each blade increase from the respective leading end to the corresponding trailing end; and
a turbine coupled to drive the rotatable shaft.

12. A method of controlling flow through a centrifugal impeller, the method comprising:
providing a centrifugal impeller including a hub and a plurality of impeller blades extending from the hub, each impeller blade extending over a chord length (CD) between a leading end and a trailing end and over a span from a root at the hub to a tip end, the plurality of impeller blades collectively or individually having profiles defining:
a circumferential pitch (CP) with regard to a spacing distance between the leading ends of neighboring ones of the blades, and
blade angles (α) along each blade between the leading end and the trailing end; and
establishing a ratio (R) of an outlet meridonal flow velocity to an inlet meridonal flow velocity (outlet meridonal flow velocity divided by inlet meridonal flow velocity) to be 0.8-1.2 by configuring the plurality of impeller blades with a solidity value (S) defined as CD/CP that is less or equal to 1.0 and with the blade angles (α) of each blade increasing from the respective leading end to the corresponding trailing end.

13. The method as recited in claim 12, including establishing the ratio (R) to be approximately 1.0.

14. The method as recited in claim 12, including, for any one of the positions along the convex side each blade, establishing the blade angle (α) to be between a first line that is tangent to the convex side of the respective blade at the position and a second line that is tangent to a mean radius line between an inner radius of the leading ends and an outer radius of the trailing ends at a point of intersection between the convex side of the respective blade and the second line.

15. The method as recited in claim 14, including establishing the blade angles (α) to be 12°-24°.

16. The method as recited in claim 14, wherein the plurality of impeller blades are rotatable with regard to a central axis, and establishing the blade angle (α) of each blade at the hub to be greater than the blade angle (α) of each blade at the tip end at an intermediate radial distance from the axis between the leading ends and the tailing ends.

17. The method as recited in claim 14, wherein the plurality of impeller blades are rotatable with regard to a central axis, and establishing the blade angle (α) of each blade at the hub to be greater than the blade angle (α) of each blade at the tip end at each of a plurality of radial distances from the axis between the leading ends and the tailing ends.

18. The method as recited in claim 14, including establishing, at the trailing end of each blade, the blade angle (α) of each blade at the hub to be equal to the blade angle (α) of each blade at the tip end.

19. The method as recited in claim 14, wherein the plurality of impeller blades are rotatable with regard to a central axis, including establishing the blade angle (α) of each blade at the hub to be greater than the blade angle (α) of each blade at the tip end at each of a plurality of radial distances from the axis between the leading ends and the tailing ends, and establishing, at the trailing end of each blade, the blade angle (α) at the hub to be equal to the blade angle (α) at the tip end, such that the blade angles (α) at the plurality of radial distances and the blade angles (α) at the trailing end of each blade at the hub and at the tip end are 12°-24°.
